(19) United States
(12) Patent Application Publication
(10) Pub. No.: US 2006/0123942 A1
(43) Pub. Date: Jun. 15, 2006

(54) Constructive arrangement in metallic gear

(76) Inventor: Arthur O.C. Facciolla, Sao Paulo (BR)

Correspondence Address: Hoffman, Wasson & Gitler, P.C.;Crystal Center 2 - Suite 522, 2461 South Clark Street, Arlington, VA, 22202, US

(21) Appl. No.: 11/010,305

(22) Filed: Dec. 14, 2004

(51) Int. Cl. F16H 55/14

(52) U.S. Cl. 74/443

(57) ABSTRACT

A metallic gear has a single circular body with central traverse hole and cogged outer edge. The single circular body may be coupled with other gears in a given transmission engine system. The individual body of the metallic gear receives on one of its faces at least one annular piece of non-rigid material, which is overlapped and pressed against the respective face by a rigid ring held next to the surface of the gear by fixing elements orthogonally applied to the face of the gear.

### FIELD OF THE INVENTION

The invention relates to metallic gears embodying, in its assembly, a noise suppressor.

### BACKGROUND OF THE INVENTION

As known by those versed in the art, engines, transmission and any system using gears become subject to shock during work whenever their rotations reach values above 500 rpm. As a consequence, in addition to wear, a high noise level may result, which can reach values above those permitted by legal regulations.

One of the adopted solutions in order to minimize noise is to arrange a plurality of holes alongside the circular body surface of the gear and orthogonal to the surface. Some kind of stretching material, usually rubber, fills the holes to absorb a portion of the vibrations generated during the rotating cycle of said gear. In spite of the satisfactory results presented by such solution, it presents a use limitation connected to the thickness of the gear. Although its application is satisfactory for gears, the application interferes with the actual structural resistance of the gear, besides not corresponding to the desired noise reducing capability.

Another conventionally known and used solution refers to the application of the break up gear concept. A gear is divided in two parts at the middle, which are interconnected in a perfect alignment by a stretching material, thereby forming a “sandwich”. Such solution achieves the absorption of vibrations and, as a consequence, the reduction of noise. However, such solution brings complexity and a high cost of production, making its general application unfeasible.

There is also another conventionally used solution including the use of an auxiliary gear aligned with the main gear. The auxiliary gear is stressed by springs whose function is to promote a back pressure to the clutching force, consequently eliminating the slack within the counter-piece. Thus, the potential shocks between coupling gear cogs are altogether eliminated. As with the previous solutions, this one presents problems making its application unfeasible. One problem is the extremely complex and costly building concept to the construction and assembly lines. Another problem is the physical volume generated by such arrangement, causing a significant occupation of space in the system and, sometimes in existent within the transmission shells, for instance, and generating within the system a substantial weight increase in relations to the other alternative solutions.

It is, therefore, an object of this invention to provide a constructive arrangement in metallic gear presenting a noise suppressor applied to gears of any thickness, without interfering with the structural resistance of the gear itself.

Another object of the invention is to provide a constructive arrangement in metallic gear presenting a noise suppressor having an uncomplicated constructivity and low production cost, making its general application feasible.

Yet another object of this invention is to provide a constructive arrangement in metallic gear presenting a noise suppressor that does not present an excessive physical volume and, as a consequence, does not occupy significant space within transmission shells.

Still another object of this invention is to provide a constructive arrangement in metallic gear that presents a noise suppressor that has a significantly lower weight when compared with other alternative solutions.

This and other objects and advantages of the invention will be become apparent to one of ordinary skill in the art after reading the disclosure of the invention.

### SUMMARY OF THE INVENTION

The objects and advantages of the invention are achieved by a constructive arrangement in a metallic gear having a single circular body with central traverse hole and cogged outer edge. The single circular body may be coupled with other gears in a given transmission engine system. The individual body of the metallic gear receives on one of its faces at least one annular piece of non-rigid material, which is overlapped and pressed against the respective face by a rigid ring held next to the surface of the gear by fixing elements orthogonally applied to the face of the gear.

### BRIEF DESCRIPTION OF THE DRAWINGS

FIG. 1 shows an exploded perspective view of the constructive arrangement introduced on the subject metallic gear,

FIG. 2 shows a perspective view of th metallic gear assembled according to the innovated constructive arrangement;

FIG. 3 shows a segment of the metallic gear shown in the previous figures;

FIG. 4 shows an exploded perspective view of a constructive variant of the constructive arrangement introduced on the subject metallic gear;

FIG. 5 shows a perspective view of the metallic gear shown in the previous figure as assembled; and

FIG. 6 shows a segment of the metallic gear shown in the FIGS. 4 and 5.

### DETAILED DESCRIPTION OF THE INVENTION

The subject metallic gear has a single circular body 10 with a central transverse hole 1 and cogged outer edge 2 for coupling with other gears 10 such as in a transmission engine system.

This single body of the metallic gear 10 receives in one of its faces 3, at least one annular piece 11 of non-rigid material. Some examples of suitable non-rigid materials includes natural or synthetic rubber, silicon, urethane, polyurethane and vellunoid. The annular piece 11 overlaps and presses against the face 3 of the gear 10 by a rigid ring 12. The rigid ring can be made from rigid plastic or metal of any type. Both the rigid ring 12 and non-rigid ring 11 are held next to the surface of gear 10 by fixation elements 13, for instance, locking screws, studs, rivets, or other conventional means which are orthogonally applied to the face 3 of the gear 10.

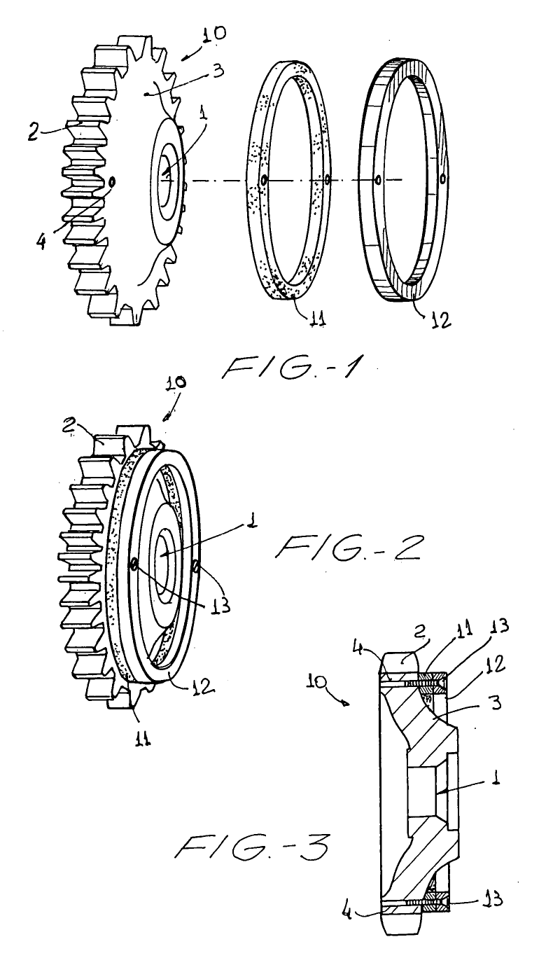

As can be seen in FIGS. 1, 2 and 3, the assembling includes the placement of the non-rigid ring 11 on the flat surface 3 of the gear 10. The nonrigid ring is covered by the solid rigid ring 12 of the rectangular transversal segment. The rigid ring is aligned and supported over the outer face of the non-rigid ring 11, being pressed over the latter by at least two locking screws 13 that pass through the rigid ring and non-rigid ring and are fixed by threading into the corresponding holes 4 provided on the face 3 of the gear 10.

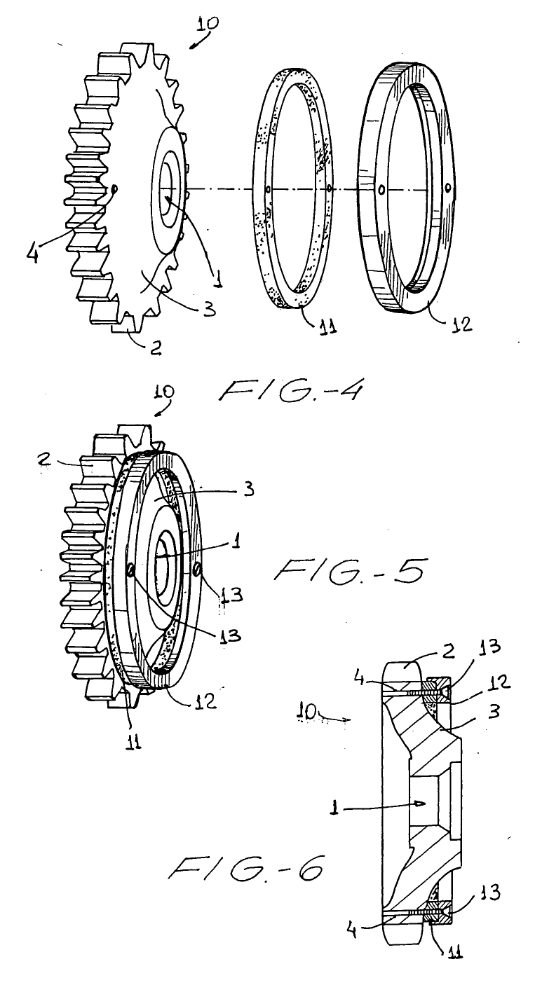

FIG. 4-6 show an alternative embodiment of the noise reducing gear. In the embodiment, the rigid ring has a depending flange extending from its outer edge. As seen in the cross sectional view of FIG. 6, the flange extends along the outer surface of the non-rigid ring 11.

Another version of the gear with noise suppressor provides a groove on the actual outer face 3 of the gear for housing the non-rigid ring 11. The nonrigid ring 11 seats within the groove and is therefor properly positioned. The non-rigid ring 11 is higher than the groove in order to extend from the face 3 of the gear and come into direct contact with the rigid ring 12 designed for pressing the non-rigid ring 11 against the gear 10.

While the invention has been described with reference to preferred embodiments, variations and modifications would be apparent to one of ordinary skill in the art. The invention encompasses such variation and modifications which do not depart from the scope of the invention.

I claim:

1. A gear comprising,
a first surface,
a second surface opposite said first surface,
an outer surface extending between said first and second surface, and
a noise suppressor attached to said first surface.

2. The gear of claim 1, wherein
said noise suppressor is a ring of non-rigid material.

3. The gear of claim 1, wherein
said noise suppressor is attached to said first surface by a retainer.

4. The gear of claim 3, wherein
said retainer is a ring made of rigid material, said noise suppressor retained between said first surface and said retainer.

5. The gear of claim 4, wherein
said noise suppressor is a being of non-rigid material.

6. The gear of claim 4, further comprising
a fastener extending through said retainer and noise suppressor and attached to said gear.

7. The gear of claim 6, wherein said fastener is a screw.
